(19) United States
(12) Patent Application Publication
(10) Pub. No.: US 2010/0111371 A1
(43) Pub. Date: May 6, 2010

(54) IMAGE SERVER WITH MULTIPLE IMAGE QUALITY PORTS

(75) Inventor: Kevin M. Crucs, Copley, OH (US)

Correspondence Address: HAHN LOESER & PARKS, LLP, One GOJO Plaza, Suite 300, AKRON, OH, 44311-1076, US

(73) Assignee: APTERYX, INC., Akron, OH (US)

(21) Appl. No.: 12/246,647

(22) Filed: Oct. 7, 2008

(51) Int. Cl. G06K 9/00; G06F 17/30

(52) U.S. Cl. 382/112; 707/E17.014

(57) ABSTRACT

Image servers, methods, software applications, and computer readable medium for retrieving images of various image quality via multiple image quality software ports. In an image server, at least two image quality software ports are provided, where each of the image quality software ports is capable of providing images at a predetermined level of image quality, and where the predetermined level of image quality is different for each of the image quality software ports.

### TECHNICAL FIELD

Certain embodiments of the present invention relate to an image server and methods of querying an image server. More particularly, certain embodiments relate to an image server providing multiple image quality software ports and methods of querying the image server for images having different levels of image quality.

### BACKGROUND

An image server is a server that is specialized for delivering images and is often used as a complement to a web server to increase the speed of image retrieval. Digital Imaging and Communications in Medicine (DICOM) is a well-known standard for transferring images and associated information between devices manufactured by various vendors. One type of image server is a DICOM database server. Typically, a DICOM database server is used to store, organize, and manage medical images. Various external systems may desire to communicate with a DICOM database server to store images to the DICOM database server and/or to retrieve images from the DICOM database server by submitting image requests to the DICOM database server.

However, the DICOM standard provides for more than the transferring and storing of digital medical images. Other DICOM functions include media storage, query/retrieve, worklist query, make image hard copies, study and results management, print management, worklist management, and test connectivity verification.

A basic concept used in the DICOM standard is that of “Services on Objects”. An example of an “object” is an X-ray image. Two examples of a “service” are the “query/retrieve” and “store” functions. In the DICOM standard, processes of operating on objects are called “Service Object Pair Classes” (SOP Classes). Examples of SOP Classes include “store an X-ray image”, “print an X-ray image”, and “retrieve a worklist”.

Unique Identifiers (UID's) are determined for SOP classes and are also applied to studies, series, and images. A patient study includes a study component such as, for example, an examination using a particular type of medical imaging machine. The images that are captured in sequence during the study on a patient form a series of objects.

The DICOM standard is founded on a client/server concept. A device that uses a service is the client device, and the device that provides the service is the server device. The client device is called a Service Class User (SCU). The server device is called a Service Class Provider (SCP). An SCU transmits a Service Request to an SCP over a network. The SCP transmits back a response to the SCU over the network. For information to be transferred between a SCP and a SCU, a communication syntax (e.g., a DICOM protocol) must be agreed upon and association between the SCU and the SCP must be opened.

The DICOM standard facilitates communication of digital medical images of various types including X-ray, computerized tomography, magnetic resonance, and ultrasound, for example. DICOM activities are administered in a queued manner via application software running on a host computer. The host computer may be an integral part of a medical imaging machine, for example, or a workstation in a medical office.

A PACS (Picture Archive and Communication System) is an image management system typically used in a radiology department of a healthcare facility such as a hospital or a doctor's office, for example. A PACS system may manage the details of imaging related tasks within a facility including acquisitions, archiving, manipulation, and display. A PACS system may be implemented in the form of a local DICOM database server and a database, for example.

A DICOM client typically needs to know which DICOM database server to select and query, depending on the information that is being requested. IP addresses and predefined software ports are often used to identify a server and a particular server application on a network. For example, a particular server application may be that of providing images to requesting clients. The concepts of IP addresses and software ports are well known in the art.

Further limitations and disadvantages of conventional, traditional, and proposed approaches will become apparent to one of skill in the art, through comparison of such approaches with the subject matter of the present application as set forth in the remainder of the present application with reference to the drawings.

### SUMMARY

A first embodiment of the present invention comprises an image server providing at least two image quality software ports, where each of the image quality software ports is capable of providing images at a predetermined level of image quality, and where the predetermined level of image quality is different for each of the image quality software ports.

Another embodiment of the present invention comprises an image server providing multiple image quality software ports. The image server includes a first software port capable of providing images at a first level of image quality. The image server further includes a second software port capable of providing the images at a second level of image quality, where the second level of image quality is different from the first level of image quality. The image server also includes a third software port capable of providing the images at a third level of image quality, where the third level of image quality is different from the first level of image quality and the second level of image quality. The first level of image quality may correspond to a maximum level of image quality for the provided images. The second level of image quality may be about 50% of the maximum level of image quality for the provided images. The third level of image quality may be about 10% of the maximum level of image quality for the provided images. As an option, the images provided by the third software port may be thumbnail images. In accordance with an embodiment of the present invention, a port number of the first software port is 104, a port number of the second software port is 105, and a port number of the third software port is 106. In accordance with an embodiment of the present invention, the image server is a Digital Imaging and Communications in Medicine (DICOM) Picture Archive and Communication System (PACS) server.

A further embodiment of the present invention comprises a method of querying an image server providing multiple image quality software ports. The method includes querying an image server by providing a first port number in a first query message, where the first port number corresponds to a first software port of the image server capable of providing images at a first level of image quality. The method further includes receiving at least one image from the image server having the first level of image quality in response to the first query message, and displaying the at least one image having the first level of image quality. The method also includes querying the image server by providing a second port number in a second query message, where the second port number corresponds to a second software port of the image server capable of providing images at a second level of image quality. The method further includes receiving the at least one image from the image server having the second level of image quality in response to the second query message, and displaying the at least one image having the second level of image quality. The method may further include querying the image server by providing a third port number in a third query message, where the third port number corresponds to a third software port of the image server capable of providing images at a third level of image quality. The method may also include receiving the at least one image from the image server having the third level of image quality in response to the third query message and displaying the at least one image having the third level of image quality.

Another embodiment of the present invention comprises a method of querying an image server. The method includes providing one of a plurality of software port numbers in a query message, where each of the plurality of software port numbers corresponds to a different image quality software port of the image server, and where the image server is capable of providing images at a different level of image quality for each image quality software port. A first software port number of the plurality of software port numbers may correspond to a first image quality software port capable of providing images at a maximum level of image quality. A second software port number of the plurality of software port numbers may correspond to a second image quality software port capable of providing images at about 50% of the maximum level of image quality. A third software port number of the plurality of software port numbers may correspond to a third image quality software port capable of providing images at about 10% of the maximum level of image quality.

A further embodiment of the present invention comprises a software application, residing on a computer-based platform, capable of querying an image server by providing one of a plurality of software port numbers in a query message, where each of the plurality of software port numbers corresponds to a different image quality software port of the image server, and where the image server is capable of providing images at a different level of image quality for each image quality software port.

Another embodiment of the present invention comprises a software application, residing on a computer-based platform. The software application is capable of querying an image server by providing a first port number in a first query message, where the first port number corresponds to a first software port of the image server capable of providing images at a first level of image quality. The software application is also capable of receiving at least one image from the image server having the first level of image quality in response to the first query message and displaying the at least one image having the first level of image quality. The software application is further capable of querying the image server by providing a second port number in a second query message, where the second port number corresponds to a second software port of the image server capable of providing images at a second level of image quality. The software application is also capable of receiving the at least one image from the image server having the second level of image quality in response to the second query message and displaying the at least one image having the second level of image quality. The software application may further be capable of querying the image server by providing a third port number in a third query message, where the third port number corresponds to a third software port of the image server capable of providing images at a third level of image quality. The software application may also be capable of receiving the at least one image from the image server having the third level of image quality and displaying the at least one image having the third level of image quality.

A further embodiment of the present invention comprises a computer readable medium having encoded thereon computer executable instructions for performing a method. The method includes querying an image server by providing one of a plurality of software port numbers in a query message, where each of the plurality of software port numbers corresponds to a different image quality software port of the image server, and where the image server is capable of providing images at a different level of image quality for each image quality software port.

Another embodiment of the present invention comprises a computer readable medium having encoded thereon computer executable instructions for performing a method. The method includes querying an image server by providing a first port number in a first query message, where the first port number corresponds to a first software port of the image server capable of providing images at a first level of image quality. The method further includes receiving at least one image from the image server having the first level of image quality in response to the first query message and displaying the at least one image having the first level of image quality. The method also includes querying the image server by providing a second port number in a second query message, where the second port number corresponds to a second software port of the image server capable of providing images at a second level of image quality. The method further includes receiving the at least one image from the image server having the second level of image quality in response to the second query message and displaying the at least one image having the second level of image quality. The method may also include querying the image server by providing a third port number in a third query message, where the third port number corresponds to a third software port of the image server capable of providing images at a third level of image quality. The method may further include receiving the at least one image from the image server having the third level of image quality in response to the third query message and displaying the at least one image having the third level of image quality.

These and other novel features of the subject matter of the present application, as well as details of illustrated embodiments thereof, will be more fully understood from the following description and drawings.

### BRIEF DESCRIPTION OF THE DRAWINGS

FIG. 1 illustrates a system that uses image servers, a software application, and multi-port methods for retrieving images of various image quality levels via multiple image quality software ports, in accordance with an embodiment of the present invention;

FIG. 2 illustrates a plurality of images retrieved using the system of FIG. 1 using an image quality software port corresponding to a lowest level of image quality, in accordance with an embodiment of the present invention;

FIGS. 3A-3C illustrate images retrieved using the system of FIG. 1 using three different image quality software ports of increasing levels of image quality, in accordance with an embodiment of the present invention; and

FIG. 4 is a flowchart of an embodiment of a method of querying an image server providing multiple image quality software ports using the system of FIG. 1.

### DETAILED DESCRIPTION

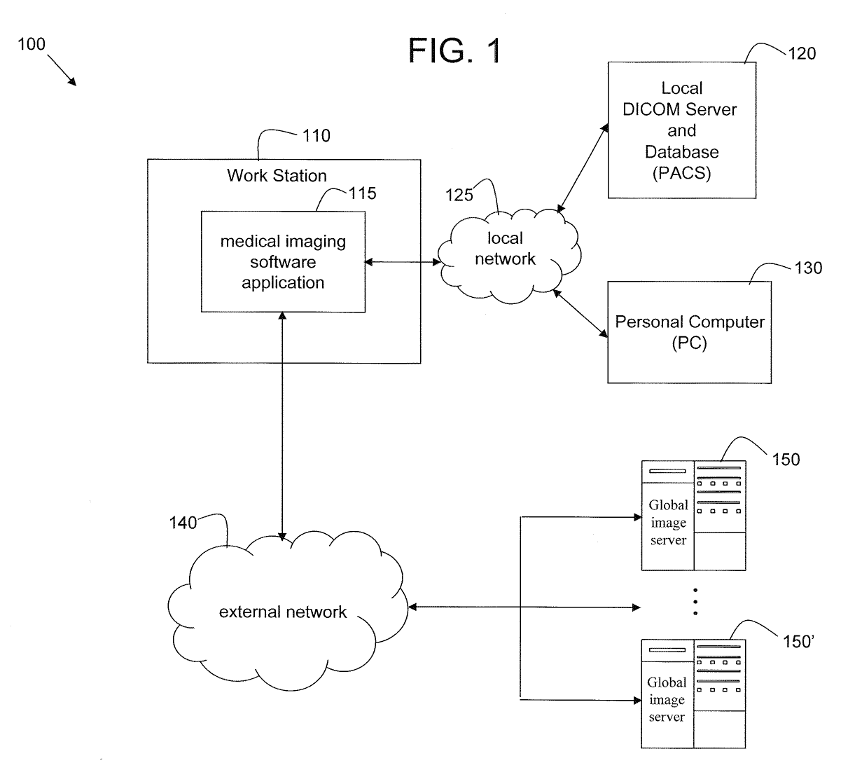

FIG. 1 illustrates a system 100 that uses image servers, a software application, and multi-port methods for retrieving images of various image quality levels via multiple image quality software ports, in accordance with an embodiment of the present invention. The system 100 includes a medical imaging software application 115 residing on a work station 110. The software application 115 is used to query image servers to retrieve medical images which may be displayed and viewed on the work station 110 by a user. The system also includes a local imaging server 120 being that of a local DICOM server and database. The local server 120 may serve as a PACS (Picture Archive and Communication System) as used in a radiology department of a healthcare facility such as a hospital or a doctor's office, for example. A PACS system may manage the details of imaging related tasks within a facility including acquisitions, archiving, manipulation, and display.

The system 100 further includes a local network 125 (e.g., a local area network) operatively connecting the work station 110 and the local server 120. The system may further include a personal computer (PC) 130 operatively connected to the local network 125. The system also includes a plurality of global image servers 150-150′ (e.g., DICOM database servers) and an external network 140 (e.g., the Internet) operatively connecting the work station 110 to the global image servers 150-150′. As used herein, the term “DICOM database server” refers to a DICOM server and associated database(s). A DICOM database server is capable of storing and/or archiving at least medical image information.

In accordance with an embodiment of the present invention, the local image server 120 and the global image servers 150-150′ each include three image quality software ports. An image quality software port, as used herein, is a software port of an image server that is capable or providing images or image data via that software port having a particular predetermined level of image quality. For example, a first software port may provide images at a maximum level of image quality, a second software port may provide images at 50% of the maximum level of image quality, and a third software port may provide images at 10% of the maximum level of image quality (e.g., thumbnail images).

A software port number uniquely identifies a particular service on a host server or computer. For example, in order for an image server to accept connections from remote workstations and computers, the image server binds each image server application to a local software port. The image server uses the local port to listen for and accept connections from remote systems. Once a remote system is connected, the image server may send the requested images to the remote system and then disconnect from the remote system when finished. In accordance with an embodiment of the present invention, image server applications corresponding to images of a particular level of image quality are bound to a particular image quality software port.

The term “image quality”, as used herein, refers to the total number of pixels or data that are used to represent an image. The more pixels or data (e.g., Megabytes) that are used to represent an image, the higher the level of image quality. An image having a lower level of image quality (e.g., having a half set of pixels) may have, for example, a lower perceived spatial resolution than the same image at a higher level of image quality (e.g., having a full set of pixels). Furthermore, the image having the lower level of image quality may have, for example, a lower perceived contrast resolution than the same image at a higher level of image quality. Other perceived differences are possible as well.

However, by allowing images to be retrieved from image servers at different levels of image quality (via multiple image quality software ports), network traffic may be reduced. For example, a user of the medical imaging software application 115 on the medical work station 110 may desire to view a set of dental X-ray images. The dental X-ray images reside on the local image server 120 or a global image server 150, and the software application 115 is capable of querying the correct image server for the images and retrieving those images (e.g., using the DICOM protocol). For example, if the desired images reside on the local image server 120 then, if the user retrieves the set of dental X-ray images at the maximum level of image quality, network traffic on the local network 125 may be greatly affected while the local image server 120 attempts to provide the many megabytes of full image quality image data to the work station 110.

The present invention, however, allows the user to initially retrieve the set of dental X-ray images at a significantly lower level of image quality (i.e., fewer megabytes), allowing the user to look at the full set of images and decide which of those images the user is really interested in for full image quality viewing. For example, the user may only be interested in one or two images of a set of a dozen images. The user may select the one or two images from the initially retrieved set of images and query the local image server 120 to retrieve those one or two images, but at a maximum level of image quality.

As a result of such a process, the overall network traffic on the local network 125 is reduced, or at least better managed. Embodiments of the present invention allow images to be retrieved at different levels of image quality by providing an image server with multiple software ports where each software port corresponds to a different level of image quality. When the medical imaging software application 115 makes a query to an image server to retrieve an image(s), the query message from the medical imaging software application 115 not only includes an IP address of the image server, but also includes an image quality software port number corresponding to the level of image quality at which the image(s) are to be retrieved.

In accordance with an embodiment of the present invention, the medical imaging software application 115 may be stored on a computer readable medium such as, for example, a compact disk (CD) for distribution. In accordance with other alternative embodiments of the present invention, the medical imaging software application 115 may reside the PC 130 which operatively interfaces to the work station 110 via the local network 125, or may reside on the local image server 120, for example.

An image server specializes in delivering images. An image server may perform specialized processing tasks that are useful to a user including, for example, image rotation, color adjustment, and image blending. In accordance with an embodiment of the present invention, an image server may process an image, having a predefined maximum level of image quality, in order to create corresponding images having lower levels of image quality. The image is the same, but the level of image quality is different. In this manner, an image server may provide duplicate images of various levels of image quality such that any particular level of image quality corresponds to a particular image quality software port of the image sever. In other words, the image server may provide multiple image retrieval applications based on image quality level, where each application is tied to a corresponding image quality software port.

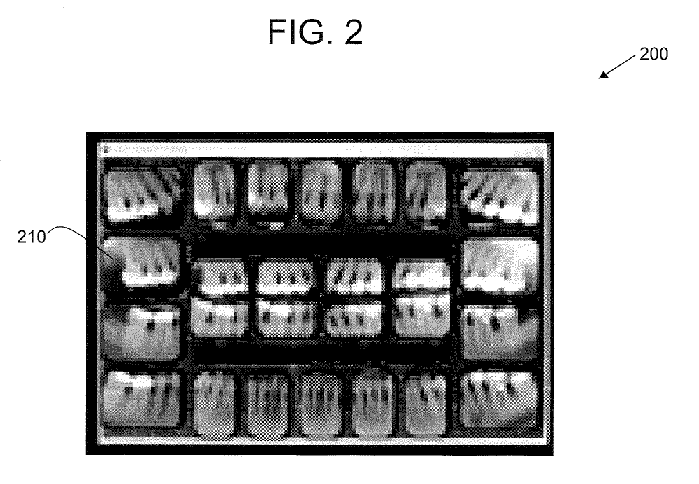

FIG. 2 illustrates a plurality of images 200 retrieved using the system 100 of FIG. 1 using an image quality software port corresponding to a lowest level of image quality, in accordance with an embodiment of the present invention. The images 200 may be displayed to a user on a display of the workstation 110, for example. The images 200 appear to be of low image quality but were able to be retrieved relatively quickly, using the lowest level image quality software port, thus keeping network traffic relatively low. The user may view the images 200 and decide he is interested in looking more closely at image 210, for example. As a result, the user selects the image 210 via the medical imaging software application 115 on the work station 110, selects a higher level of desired image quality, and again sends out a query message to retrieve only the image 210, but at the selected higher level of image quality.

When the user selects a higher level of desired image quality, the query message will include a different image quality software port number of the image server. For example, the original set of images 200 may have been queried and retrieved using software port number 104 corresponding to a DICOM image quality port of the image server providing a lowest level of image quality. The image 210 may then be queried and retrieved in a second query message using software port number 106 corresponding to a DICOM image quality port of the image server providing a maximum level of image quality.

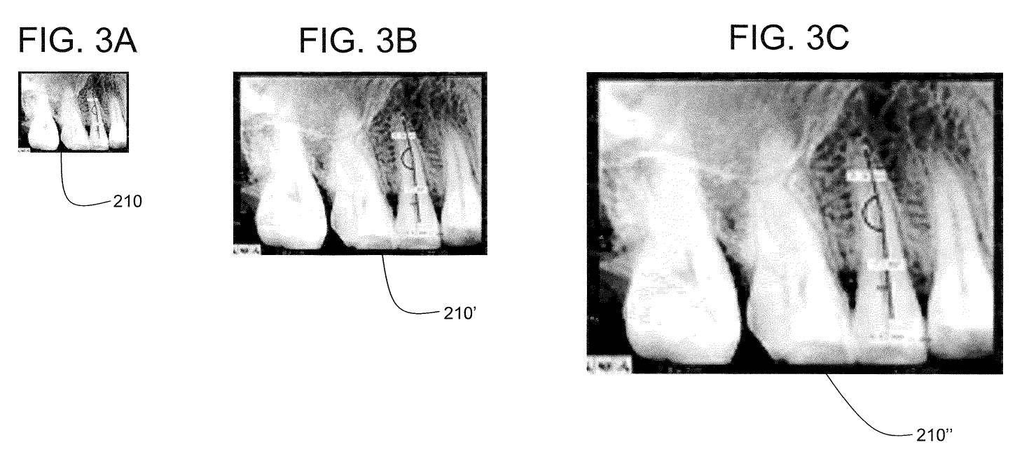

For example, FIGS. 3A-3C illustrate images retrieved using the system of FIG. 1 using three different image quality software ports of increasing levels of image quality, in accordance with an embodiment of the present invention. The image 210 was retrieved via a first image quality software port of an image server providing a lowest level of image quality (e.g., as a thumbnail image using software port number 104). The image 210′ was retrieved via a second image quality software port of the same image server providing an intermediate level of image quality (e.g., 50% of a maximum level of image quality using software port number 105). The image 210″ was retrieved via a third image quality software port of the same image server providing a maximum level of image quality (e.g., software port number 106). The images 210, 210′, and 210″ are all the same image, but each at a different level of image quality.

The process of selecting a level of image quality (i.e., an image quality software port number) may be done manually by a user or automatically by the medical imaging software application 115. For example, the medical imaging software application 115 may be configured to always use the lowest image quality port number any time six or more images are to be retrieved based on a single query. Furthermore, the medical imaging software application 115 may be configured to always use the maximum image quality port number whenever a single image is to be retrieved based on a single query. Other rules of automation may be defined as well.

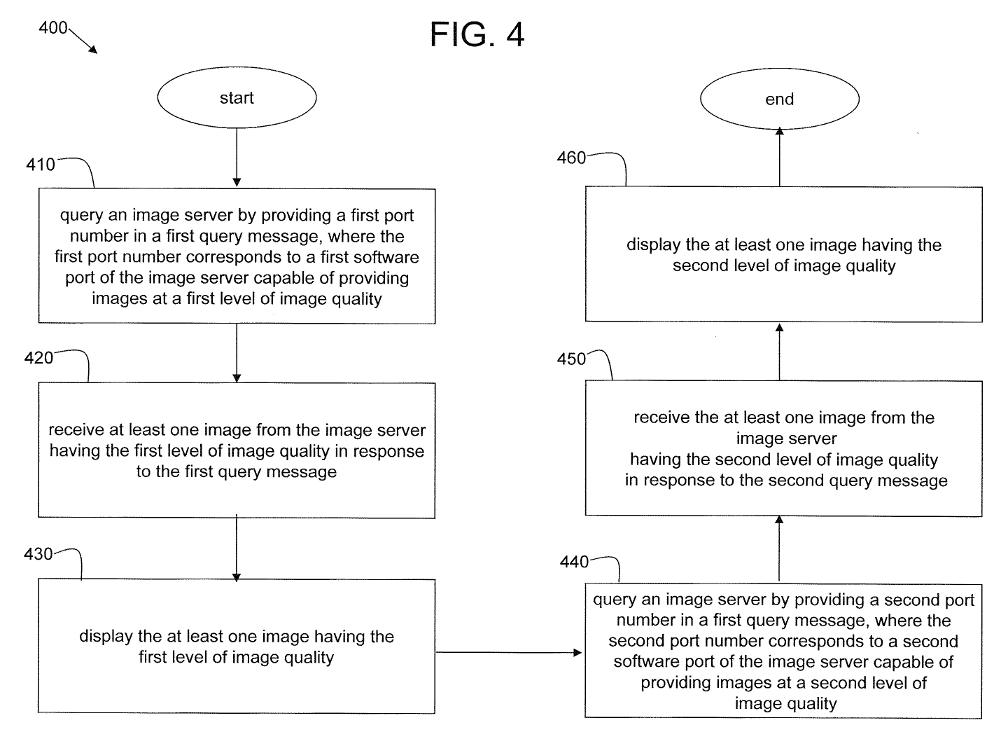

FIG. 4 is a flowchart of an embodiment of a method 400 of querying an image server providing multiple image quality software ports using the system of FIG. 1. In step 410, query an image server by providing a first port number in a first query message, where the first port number corresponds to a first software port of the image server capable of providing images at a first level of image quality. In step 420, receive at least one image from the image server having the first level of image quality in response to the first query message. In step 430, display the at least one image having the first level of image quality. In step 440, query the image server by providing a second port number in a second query message, where the second port number corresponds to a second software port of the image server capable of providing images at a second level of image quality. In step 450, receive the at least one image from the image server having the second level of image quality in response to the second query message. In step 460, display the at least one image having the second level of image quality.

In summary, image servers, methods, software applications, and computer readable medium for retrieving images of various image quality via multiple image quality software ports are disclosed. In an image server, at least two image quality software ports are provided, where each of the image quality software ports is capable of providing images at a predetermined level of image quality, and where the predetermined level of image quality is different for each of the image quality software ports. Even though discussed herein in terms of medical image applications, certain other embodiments of the present invention may apply to other image retrieval applications as well.

While the claimed subject matter of the present application has been described with reference to certain embodiments, it will be understood by those skilled in the art that various changes may be made and equivalents may be substituted without departing from the scope of the claimed subject matter. In addition, many modifications may be made to adapt a particular situation or material to the teachings of the claimed subject matter without departing from its scope. Therefore, it is intended that the claimed subject matter not be limited to the particular embodiment disclosed, but that the claimed subject matter will include all embodiments falling within the scope of the appended claims.

What is claimed is:

1. An image server providing at least two image quality software ports, wherein each of said image quality software ports is capable of providing images at a predetermined level of image quality, and wherein said predetermined level of image quality is different for each of said image quality software ports.

2. An image server providing multiple image quality software ports, said image server comprising:
a first software port capable of providing images at a first level of image quality;
a second software port capable of providing said images at a second level of image quality, wherein said second level of image quality is different from said first level of image quality; and
a third software port capable of providing said images at a third level of image quality, wherein said third level of image quality is different from said first level of image quality and said second level of image quality.

3. The image server of claim 2 wherein said first level of image quality corresponds to a maximum level of image quality for said provided images.

4. The image server of claim 3 wherein said second level of image quality is about 50% of the maximum level of image quality for said provided images.

5. The image server of claim 4 wherein said third level of image quality is about 10% of the maximum level of image quality for said provided images.

6. The image server of claim 2 wherein said images provided by said third software port are thumbnail images.

7. The image server of claim 2 wherein a port number of said first software port is 104.

8. The image server of claim 7 wherein a port number of said second software port is 105.

9. The image server of claim 8 wherein a port number of said third software port is 106.

10. The image server of claim 2 wherein said image server comprises a Digital Imaging and Communications in Medicine (DICOM) Picture Archive and Communication System (PACS) server.

11. A method of querying an image server providing multiple image quality software ports, said method comprising:
querying an image server by providing a first port number in a first query message, wherein said first port number corresponds to a first software port of said image server capable of providing images at a first level of image quality;
receiving at least one image from said image server having said first level of image quality in response to said first query message;
displaying said at least one image having said first level of image quality;
querying said image server by providing a second port number in a second query message, wherein said second port number corresponds to a second software port of said image server capable of providing images at a second level of image quality; and
receiving said at least one image from said image server having said second level of image quality in response to said second query message.

12. The method of claim 11 further comprising displaying said at least one image having said second level of image quality.

13. The method of claim 12 further comprising:
querying said image server by providing a third port number in a third query message, wherein said third port number corresponds to a third software port of said image server capable of providing images at a third level of image quality; and
receiving said at least one image from said image server having said third level of image quality in response to said third query message.

14. The method of claim 13 further comprising displaying said at least one image having said third level of image quality.

15. A method of querying an image server, said method comprising providing one of a plurality of software port numbers in a query message, wherein each of said plurality of software port numbers corresponds to a different image quality software port of said image server, and wherein said image server is capable of providing images at a different level of image quality for each image quality software port.

16. The method of claim 15 wherein a first software port number of said plurality of software port numbers corresponds to a first image quality software port capable of providing images at a maximum level of image quality.

17. The method of claim 16 wherein a second software port number of said plurality of software port numbers corresponds to a second image quality software port capable of providing images at about 50% of said maximum level of image quality.

18. The method of claim 17 wherein a third software port number of said plurality of software port numbers corresponds to a third image quality software port capable of providing images at about 10% of said maximum level of image quality.

19. A software application, residing on a computer-based platform, capable of querying an image server by providing one of a plurality of software port numbers in a query message, wherein each of said plurality of software port numbers corresponds to a different image quality software port of said image server, and wherein said image server is capable of providing images at a different level of image quality for each image quality software port.

20. A software application, residing on a computer-based platform, said software application being capable of:
querying an image server by providing a first port number in a first query message, wherein said first port number corresponds to a first software port of said image server capable of providing images at a first level of image quality;
receiving at least one image from said image server having said first level of image quality in response to said first query message;
displaying said at least one image having said first level of image quality;
querying said image server by providing a second port number in a second query message, wherein said second port number corresponds to a second software port of said image server capable of providing images at a second level of image quality; and
receiving said at least one image from said image server having said second level of image quality in response to said second query message.

21. The software application of claim 20, wherein said software application is further capable of displaying said at least one image having said second level of image quality.

22. The software application of claim 21, wherein said software application is further capable of:
querying said image server by providing a third port number in a third query message, wherein said third port number corresponds to a third software port of said image server capable of providing images at a third level of image quality; and
receiving said at least one image from said image server having said third level of image quality in response to said third query message.

23. The software application of claim 22, wherein said software application is further capable of displaying said at least one image having said third level of image quality.

24. A computer readable medium having encoded thereon computer executable instructions for performing a method, wherein said method comprises querying an image server by providing one of a plurality of software port numbers in a query message, wherein each of said plurality of software port numbers corresponds to a different image quality software port of said image server, and wherein said image server is capable of providing images at a different level of image quality for each image quality software port.

25. A computer readable medium having encoded thereon computer executable instructions for performing a method, wherein said method comprises:
querying an image server by providing a first port number in a first query message, wherein said first port number corresponds to a first software port of said image server capable of providing images at a first level of image quality;
receiving at least one image from said image server having said first level of image quality in response to said first query message;
displaying said at least one image having said first level of image quality;
querying said image server by providing a second port number in a second query message, wherein said second port number corresponds to a second software port of said image server capable of providing images at a second level of image quality; and
receiving said at least one image from said image server having said second level of image quality in response to said second query message.

26. The computer readable medium of claim 25 wherein said method further comprises
displaying said at least one image having said second level of image quality.

27. The computer readable medium of claim 26 wherein said method further comprises:
querying said image server by providing a third port number in a third query message, wherein said third port number corresponds to a third software port of said image server capable of providing images at a third level of image quality; and
receiving said at least one image from said image server having said third level of image quality in response to said third query message.

28. The computer readable medium of claim 27 wherein said method further comprises
displaying said at least one image having said third level of image quality.
